(19) United States
(12) Patent Application Publication
(10) Pub. No.: US 2022/0005000 A1
(43) Pub. Date: Jan. 6, 2022

(54) MAINTENANCE WORK INSTRUCTION SYSTEM, MAINTENANCE WORK INSTRUCTION METHOD, AND PROGRAM

(71) Applicant: NEC Corporation, Minato-ku, Tokyo (JP)

(72) Inventor: Nozomi SHIMADA, Tokyo (JP)

(73) Assignee: NEC Corporation, Minato-ku, Tokyo (JP)

(21) Appl. No.: 17/294,805

(22) PCT Filed: Nov. 19, 2019
(86) PCT No.: PCT/JP2019/045223

§ 371 Date: May 18, 2021

(30) Foreign Application Priority Data
Nov. 20, 2018 (JP) 2018-217092

(51) Int. Cl. G06Q 10/00; G06Q 10/06; G05B 23/02

(52) U.S. Cl. CPC G06Q 10/20; G05B 23/0262; G06Q 10/06311

(57) ABSTRACT

To efficiently instruct maintenance workers if failure reports having different contents are issued in a short time period. The control part of the maintenance work instruction system, if a failure report is received from a monitored apparatus to which the first timer is not set, sets the first value to the first timer. After that, during a time period until a value of the first timer comes, if a failure report is received from an identical monitored apparatus, the control part of the maintenance work instruction system sets the second value shorter than the first value to the second timer. Then the control part of the maintenance work instruction system aggregates received failure reports during a time period after the first failure report until a lapse of time defined by the first value or a lapse of time defined by the second value in the second timer, whichever comes first.

### REFERENCE TO RELATED APPLICATION

The present invention is based upon and claims the benefit of the priority of Japanese patent application No. 2018-217092, filed on Nov. 20, 2018, the disclosure of which is incorporated herein in its entirety by reference thereto.

### FIELD

The present invention relates to a maintenance work instruction system, a maintenance work instruction method, and a program.

### BACKGROUND

A monitoring system which reports occurrence of a failure and so on of a monitored apparatus is known. If a monitored apparatus issues a failure alert (failure report) in this type of a monitoring system, it is required to respond promptly. On the other hand, in recent years, due to reduction of employment cost of maintenance workers and so on, a need for dealing with it efficiently by a small numbers of maintenance workers is increasing. Under such circumstances, a method which enables maintenance workers to deal with it promptly and efficiently is required.

For example, Patent Literature (PTL) 1 discloses a failure management method capable of taking a working situation of a maintenance worker into consideration without depending upon human skill of a manager, and adequately and quickly performing coping support against a failure that occurs in an external apparatus installed at a remote place.

Furthermore, PTL 2 discloses a report reduction system which can improve service by deciding a time period of report reduction and whether or not a notice to workers is necessary in accordance with fault contents of the report. Concretely, this report reduction system operates as below. A report decision means 1c decides whether a report acquired from a report terminal 2 via a communication network 5 is an identical report or a first report. In the case of a first report, a first report processing means 1d refers to a reduction information storage means 1a to acquire a time period of reduction and a type of reduction associated with fault contents included in the report. Furthermore, the first report processing means 1d registers a reduction completion time based on the acquired time period of reduction and the acquired type of reduction by associating them in a reduction object storage means 1b, and sends a report to a center 3. On the other hand, in the case of an identical report, an identical report processing means 1e suppresses transmission of the report to the center 3. Furthermore, in accordance with the type of reduction corresponding to the report, the reduction object storage means 1b transmits reference information based on the report to a worker terminal 4. A report deletion means if of the report reduction system deletes a report(s) which has passed the reduction completion time from the reduction object storage means 1b.

### CITATION LIST

### Patent Literature

PTL 1: Japanese Patent JP-P5700068B
PTL 2: Japanese Patent Kokai Publication No. JP-P2005-284696A

### SUMMARY

### Technical Problem

The following analysis has been given from a view of the present invention. As pointed out in PTL 2, in a method of PTL 1, there is a problem in which a number of failure reports or failure reports having duplicated contents, which are automatically issued from the monitored apparatus, are notified to maintenance workers in a short time period. In particular, if failure reports having different contents are issued in a short time period, because a plurality of maintenance workers are selected and respective communication terminals are notified, there is a possibility that excessive personnel resources will be assigned.

On the other hand, in a method of PTL 2, although, after a first report, it is possible to reduce an identical report(s) during a time period according to the fault contents, if failure reports having different contents are issued in a short time period, a plurality of maintenance workers are selected in the same way as described in PTL 1.

It is an object of the present invention to provide a maintenance work instruction system, a maintenance work instruction method, and a program which enable to efficiently instruct maintenance workers if failure reports having different contents are issued in a short time period.

### Solution to Problem

According to a first aspect, there is provided a maintenance work instruction system, including: a first timer and a second timer managed for each monitored apparatus and a reception part which receives a failure report(s) from the monitored apparatus. The maintenance work instruction system further includes a maintenance worker selection part which selects a maintenance worker(s) on the basis of the failure report(s) received during a predetermined time period. The maintenance work instruction system further includes a notification part which transmits a work instruction to the selected maintenance worker(s). The maintenance work instruction system further includes a control part which determines a first value and a second value on the basis of information included in the failure report(s) and sets them to the first timer and the second timer. The control part of the maintenance work instruction system, if a failure report is received from a monitored apparatus to which the first timer is not set, sets the first value to the first timer, and after that, during a time period until a value of the first timer comes, if a failure report is received from an identical monitored apparatus, by setting the second value shorter than the first value to the second timer, aggregates received failure reports during a time period after the first failure report until a lapse of time defined by the first value or a lapse of time defined by the second value in the second timer, whichever comes first.

According to a second aspect, there is provided a maintenance work instruction method, by a computer including: a first timer and a second timer managed for each monitored apparatus; a reception part which receives a failure report(s) from the monitored apparatus; a maintenance worker selection part which selects a maintenance worker(s) on the basis of the failure report(s) received during a predetermined time period; a notification part which transmits a work instruction to the selected maintenance worker(s); and a control part which determines a first value and a second value on the basis of information included in the failure report(s) and sets them to the first timer and the second timer. Concretely, the computer, if a failure report is received from a monitored apparatus to which the first timer is not set, sets the first value to the first timer. After that, during a time period until a value of the first timer comes, if a failure report is received from an identical monitored apparatus, by setting the second value shorter than the first value to the second timer, the computer aggregates received failure reports during a time period after the first failure report until a lapse of time defined by the first value or a lapse of time defined by the second value in the second timer, whichever comes first. The present method is tied to a particular machine, namely, a computer which functions as a maintenance work instruction system described above.

According to a third aspect, there is provided a computer program which is able to be executed by a computer functioning as a maintenance work instruction system. It is to be noted that this program can be recorded on a computer-readable (non-transitory) storage medium. That is, the present invention can be implemented as a computer program product.

### Advantageous Effects of Invention

According to the present invention, it is possible to efficiently instruct maintenance workers if failure reports having different contents are issued in a short time period. That is, the present invention converts the maintenance work instruction system as described in the background technology to one whose performance is dramatically improved in terms of a failure notification function.

### BRIEF DESCRIPTION OF DRAWINGS

FIG. 1 is a diagram illustrating a configuration according to an example embodiment of the present invention.

FIG. 2 is a diagram illustrating an operation according to the example embodiment of the present invention.

FIG. 3 is a diagram illustrating an operation according to the example embodiment of the present invention.

FIG. 4 is a diagram illustrating an operation according to the example embodiment of the present invention.

FIG. 5 is a diagram illustrating a configuration according to a first example embodiment of the present invention.

FIG. 6 is a diagram illustrating a configuration of a maintenance work instruction system according to the first example embodiment of the present invention.

FIG. 7 is a diagram illustrating an example of data held in a maintenance worker information table of the maintenance work instruction system according to the first example embodiment of the present invention.

FIG. 8 is a diagram illustrating an example of data held in a failure report storage part of the maintenance work instruction system according to the first example embodiment of the present invention.

FIG. 9 is a flowchart illustrating a processing flow of the maintenance work instruction system according to the first example embodiment of the present invention.

FIG. 10 is a flowchart illustrating a processing flow of maintenance worker selection processing of the maintenance work instruction system according to the first example embodiment of the present invention.

FIG. 11 is a diagram illustrating data storage status in a failure report storage part of the maintenance work instruction system according to the first example embodiment of the present invention.

FIG. 12 is a diagram illustrating an example of a priority list of the maintenance workers created by the maintenance work instruction system according to the first example embodiment of the present invention.

FIG. 13 is another diagram illustrating data storage status in the failure report storage part of the maintenance work instruction system according to the first example embodiment of the present invention.

FIG. 14 is a diagram illustrating a configuration of a computer making up the maintenance work instruction system of the present invention.

### DESCRIPTION OF EXAMPLE EMBODIMENTS

First, an outline of an example embodiment of the present invention will be described with reference to drawings. Note, in the following outline, reference signs of the drawings are denoted to each element as an example for the sake of convenience to facilitate understanding and the present invention is not intended to be limited to modes illustrated in drawings. An individual connection line between blocks in an individual diagram and so on referred to in the following description includes both one-way and two-way directions. A one-way arrow schematically illustrates a principal signal (data) flow and does not exclude bidirectionality. Furthermore, while not illustrated, a port(s) or an interface(s) exists(exist) at connection points of an input(s) and an output(s) of each block in diagrams. A program is executed through a computer apparatus and the computer apparatus includes, for example, a processor(s), a storage apparatus(es), an input/output apparatus(es), a communication interface(s), and a display apparatus(es), as needed. Furthermore, a computer apparatus is configured to be able to communicate with an apparatus inside or outside of the apparatus (including a computer) through a communication interface regardless of whether it is wired or wireless. Furthermore, in the following descriptions, “A and/or B” is used to mean at least one of A or B.

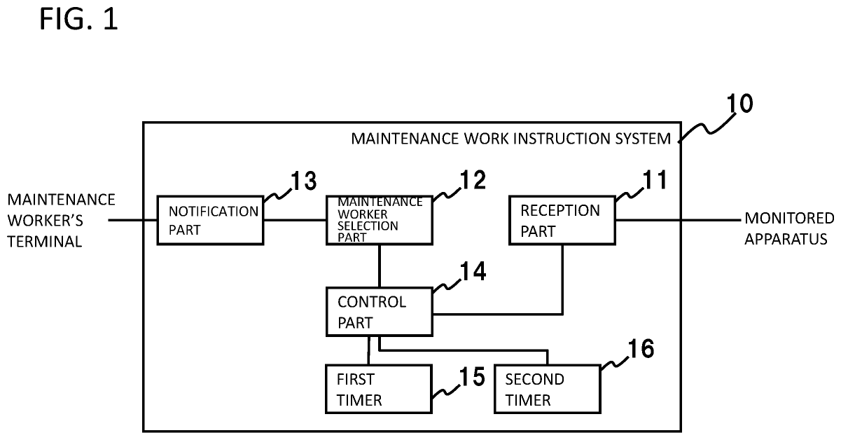

In an example embodiment, as shown in FIG. 1, the present invention can be realized by a maintenance work instruction system 10 which includes a first timer 15, a second timer 16, a reception part 11, a maintenance worker selection part 12, a notification part 13, and a control part 14. The first timer 15 and the second timer 16 are managed for each monitored apparatus. The reception part 11 receives a failure report(s) from the monitored apparatus having a function of automatically reporting a failure, and so on. The maintenance worker selection part 12 selects a maintenance worker(s) on the basis of the failure report(s) received during a predetermined time period. The notification part 13 transmits a work instruction to the selected maintenance worker(s). The control part 14 determines a first value and a second value on the basis of information included in the failure report(s) and sets them to the first timer and the second timer. Furthermore, if a failure report from a monitored apparatus to which the first timer 15 is not set is received, the control part 14 sets the first value to the first timer. After that, during a time period until a value of the first timer comes, if a failure report is received from an identical monitored apparatus, the control part 14 sets the second value shorter than the first value to the second timer. As a result, the control part 14 aggregates received failure reports during a time period after the first failure report until a lapse of time defined by the first value or a lapse of time defined by the second value in the second timer, whichever comes first.

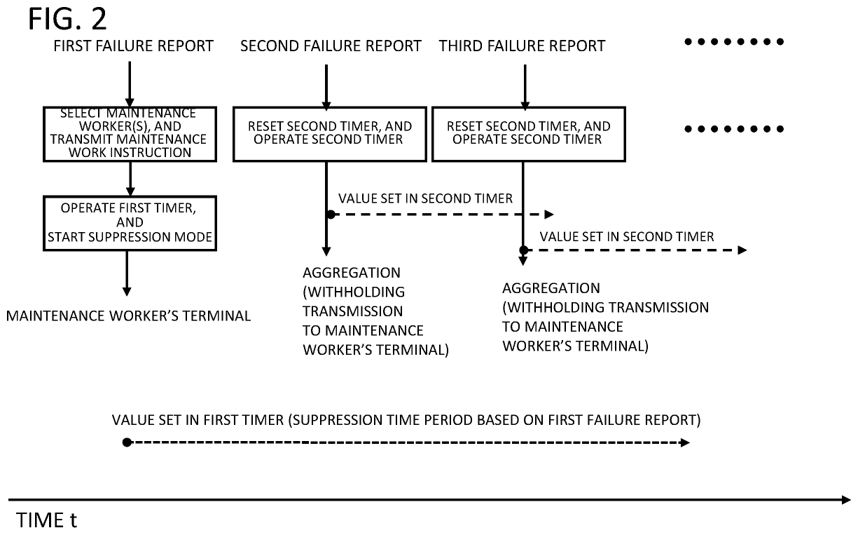

A mechanism for aggregating a failure report(s) of the above maintenance work instruction system 10 will be described in detail with reference to FIG. 2 to FIG. 4. As shown in FIG. 2, when a first failure report is received, the maintenance work instruction system 10 selects a maintenance worker(s) on the basis of the failure report and transmits a maintenance work instruction to the selected maintenance worker(s). Subsequently, the maintenance work instruction system 10 sets a predetermined value X to a first timer 15 and starts its operation. Here, it is assumed that the first timer 15 counts down from time X. After that, mode transition is performed to an suppression mode in which transmission of a maintenance work instruction triggered by reception of a failure report is suppressed. This suppression mode at least continues during a time period of a value set in the first timer 15.

In the suppression mode, if a failure report is received from an identical monitored apparatus, as shown in FIG. 2, the maintenance work instruction system 10 suppresses transmission of a maintenance work instruction to a maintenance worker(s). On the other hand, the maintenance work instruction system 10 resets a second timer 16 and starts its operation every time a failure report is received. Here, it is assumed that Y which is shorter than X is set to the second timer 16 and the second timer 16 counts down from time Y.

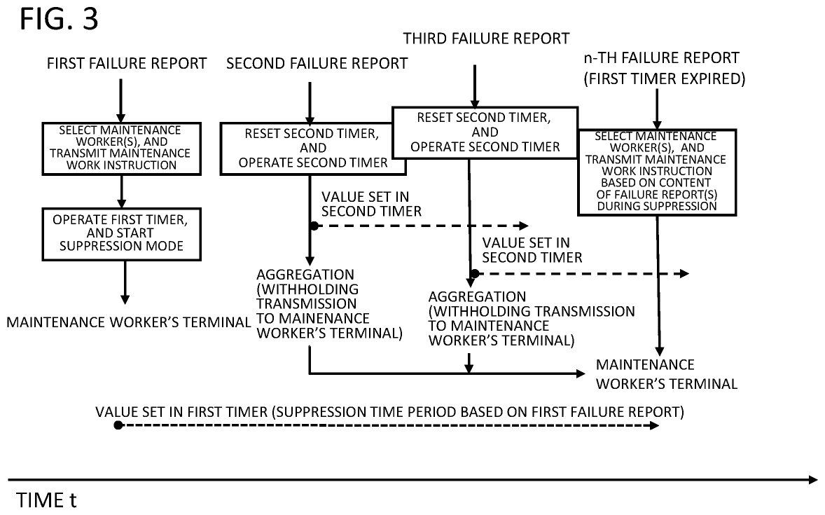

The maintenance work instruction system 10 which operates as described above transmits a second maintenance work instruction if any one of following two conditions is satisfied. One is a case in which a timer value of the first timer 15 becomes 0 (zero) as shown in FIG. 3. In this case, the maintenance work instruction system 10 selects a maintenance worker(s) on the basis of content of a failure report(s) which has/have been received during suppression and transmits a maintenance work instruction to the selected maintenance worker(s). At this time, although the same maintenance worker(s) as those at the time of the first failure report may be selected, by transmitting the content of the failure report(s) which has/have been received during suppression to the maintenance worker(s), it can be used for the maintenance work.

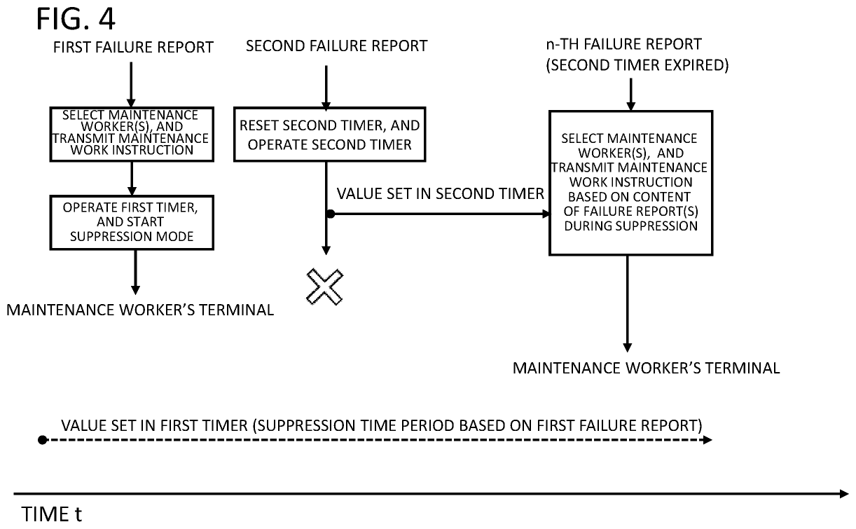

Another case in which a second maintenance work instruction is transmitted is a case in which the second timer 16 expires before the first timer 15 expires, as shown in FIG. 4. In this case, the maintenance work instruction system 10 also selects a maintenance worker(s) on the basis of content of a failure report(s) which has/have been received during suppression and transmits a maintenance work instruction to the selected maintenance worker(s). At this time, although the same maintenance worker(s) as those at the time of the first failure report may also be selected, by transmitting the content of the failure report(s) which has/have been received during suppressions to the maintenance worker(s), it can be used for the maintenance work. A failure report transmitted by this second timer 16 can be said to be a collection of failure information concentrated during a certain time period. By transmitting the collection of such failure information to a maintenance worker(s) without waiting expiration of the first timer 15, it enables to promote a prompt and accurate response.

As described above, according to the present example embodiment, it is possible not only to aggregates failure reports issued form an identical apparatus during a predetermined time period after a first failure report but also to promote a prompt response by early finishing a suppression mode using the second timer 16.

Please note that a mode for aggregating failure reports is not limited to the example described as above. For example, a method for creating statistic information of failure reports (for example, the number of failure reports, density thereof (reception intervals), and so on) received from an identical apparatus and creating digest information, during a time period determined by the above two timers, can be employed. By notifying a maintenance worker(s) of these pieces of information, it can be used for the maintenance work.

### First Example Embodiment

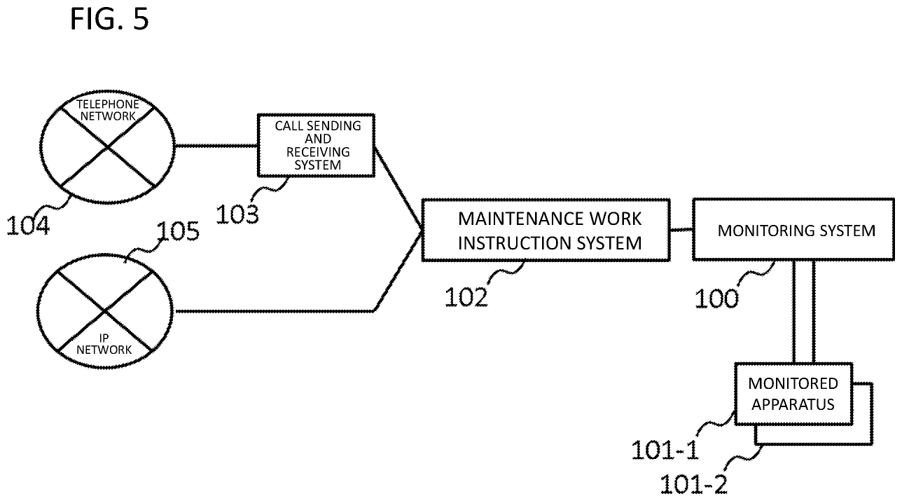

Next, a first example embodiment of the present invention will be described in detail with reference to drawings. FIG. 5 is a diagram illustrating a configuration according to the first example embodiment of the present invention. With reference to FIG. 5, a configuration in which a monitoring system 100 and a maintenance work instruction system 102 are connected is illustrated.

The monitoring system 100 is connected to monitored apparatuses 101-1 to 101-2 and monitors these apparatuses. The monitoring system 100 includes a function to automatically transmit a failure report(s) (failure alert(s)) to the maintenance work instruction system 102 when a failure(s) is detected in the monitored apparatuses 101-1 to 101-2. Please note that although the two monitored apparatuses 101-1 to 101-2 are illustrated in an example as shown in FIG. 5, the number of monitored apparatuses is not limited thereto.

The maintenance work instruction system 102 is connected to a call sending and receiving system 103 and an IP (Internet Protocol) network 105. When a failure report (failure alert) is received from the monitoring system 100, the maintenance work instruction system 102 determines a maintenance worker(s) on the basis of its content and transmits a maintenance work instruction to the corresponding maintenance worker(s). For the maintenance work instruction, either a mode of making a call to a telephone of the maintenance worker of a telephone network 104 through the call sending and receiving system 103 or a mode of sending a mail through the IP network 105 can be employed.

Please note that although each apparatus and each system shown in FIG. 5 are independently illustrated physically, it is not necessary to be in such way and may not be independent. Furthermore, each apparatus and each system shown in FIG. 5 may be a virtual one. Furthermore, each apparatus and each system shown in FIG. 5 can be divided by segmenting them at a certain granularity.

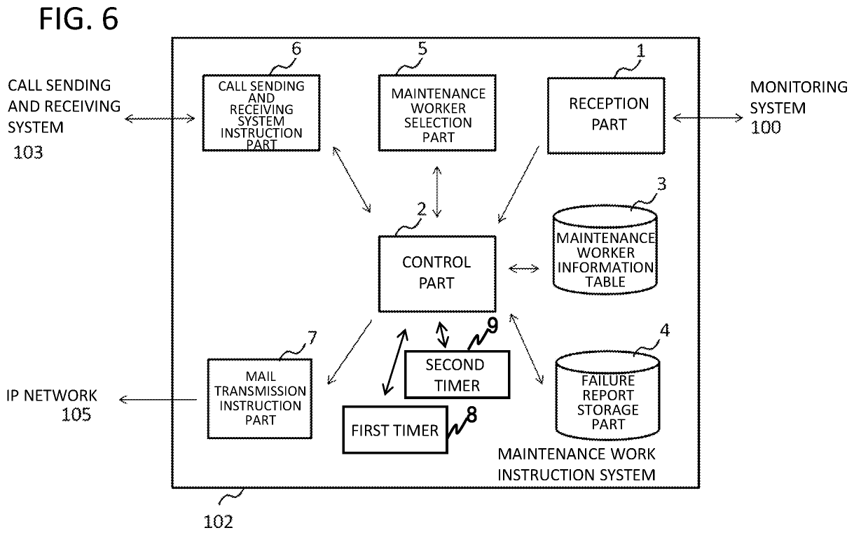

Next, a detailed configuration of the maintenance work instruction system 102 will be described. FIG. 6 is a diagram illustrating a configuration of a maintenance work instruction system 102 according to the first example embodiment of the present invention. With reference to FIG. 6, a configuration including a reception part 1, a control part 2, a maintenance worker information table 3, a failure report storage part 4, a maintenance worker selection part 5, a call sending and receiving system instruction part 6, a mail transmission instruction part 7, a first timer 8, and a second timer 9 is illustrated.

The reception part 1 receives a failure report (failure alert) issued from the monitoring system 100 and transmits it to the control part 2.

The control part 2 controls each part of the maintenance work instruction system 102 and performs a failure report (failure alert) processing. Details thereof will be explained later as an operation of the maintenance work instruction system 102.

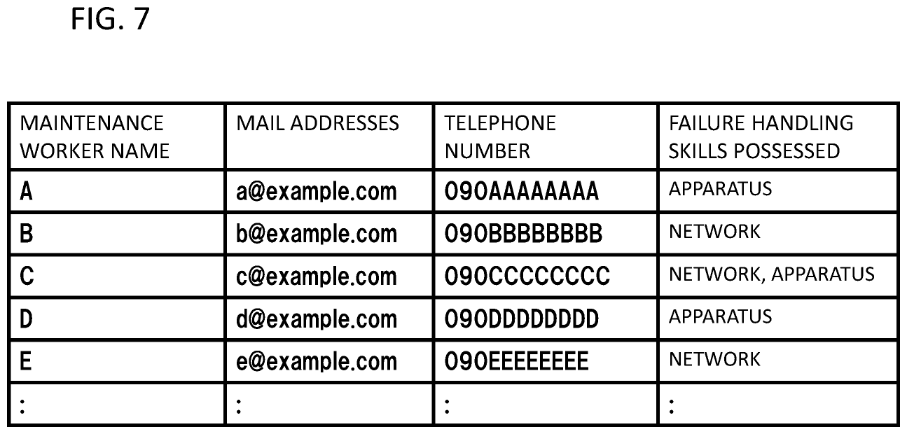

The maintenance worker information table 3 is a table which stores information of a maintenance worker(s) to be dispatched. FIG. 7 is a diagram illustrating an example of data held in a maintenance worker information table. In an example as shown in FIG. 7, for each maintenance worker, a mail address to be a contact point, a telephone number, and failure handling skills possessed by a maintenance worker are registered in association with each other. For example, because a failure handling skill possessed by a maintenance worker A is “apparatus”, it is indicated that it is possible to handle a failure of apparatus system (hardware system). Please note that an example as shown in FIG. 7 is just an example and further segmented failure handling skills may be registered. Furthermore, in addition to information of FIG. 7, presence information such as a present position of each maintenance worker and information as to whether or not each maintenance worker can be dispatched, and so on are registered and a maintenance worker(s) may be selected on the basis of these pieces of information.

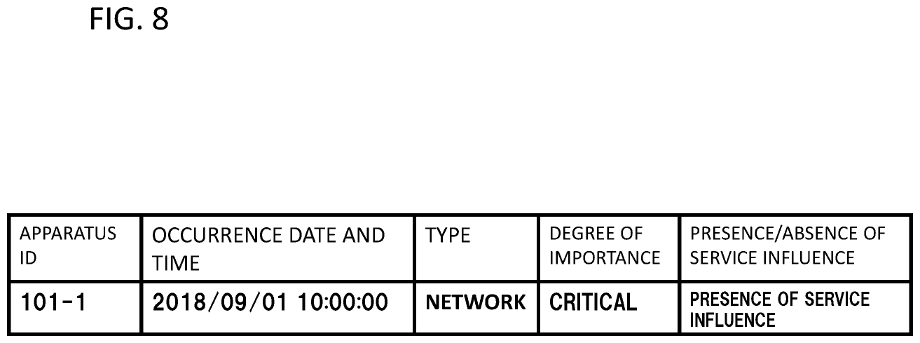

The failure report storage part 4 temporarily stores a failure report(s) (failure alert(s)) issued from the monitoring system 100. FIG. 8 is a diagram illustrating an example of data held in the failure report storage part 4. Failure information of FIG. 8 includes information such as apparatus ID in which apparatus a failure has occurred, occurrence date and time of a failure, type of a failure, degree of importance, and whether or not there is influence on service, and so on, received from the monitoring system 100. Immediately after a first failure report (failure alert) is received, one failure report (failure alert) is held in the failure report storage part 4 as shown in FIG. 8.

The maintenance worker selection part 5 selects an appropriate maintenance worker(s) from the maintenance worker information table 3 on the basis of the failure report (failure alert) held in the failure report storage part 4.

The call sending and receiving system instruction part 6 instructs the call sending and receiving system 103 to make a call to a telephone of the selected maintenance worker under control from the control part 2. When a maintenance work instruction is notified by telephone, it is possible to employ a method of notifying a maintenance work instruction by automated voice.

The mail transmission instruction part 7 instructs to transmit an e-mail including a maintenance work instruction to a mail address of the selected maintenance worker under control from the control part 2.

Please note that it is possible not to use a telephone for a maintenance work instruction to a maintenance worker. In this case, the call sending and receiving system instruction part 6 can be omitted. In the same way, if an e-mail is not used for a maintenance work instruction to a maintenance worker, the mail transmission instruction part 7 can be omitted.

The first timer 8 and the second timer 9 are controlled by the control part 2 and, when time set to each of them elapses, notify the control part 2 of the fact.

Next, an operation of the present example embodiment will be described in detail with reference to drawings. In the following description, the operation of the maintenance work instruction system 102 will be described using an example in which the monitoring system 100 detects a failure related to a network and a plurality of related failure reports (failure alerts) are continuously issued within a predetermined time period.

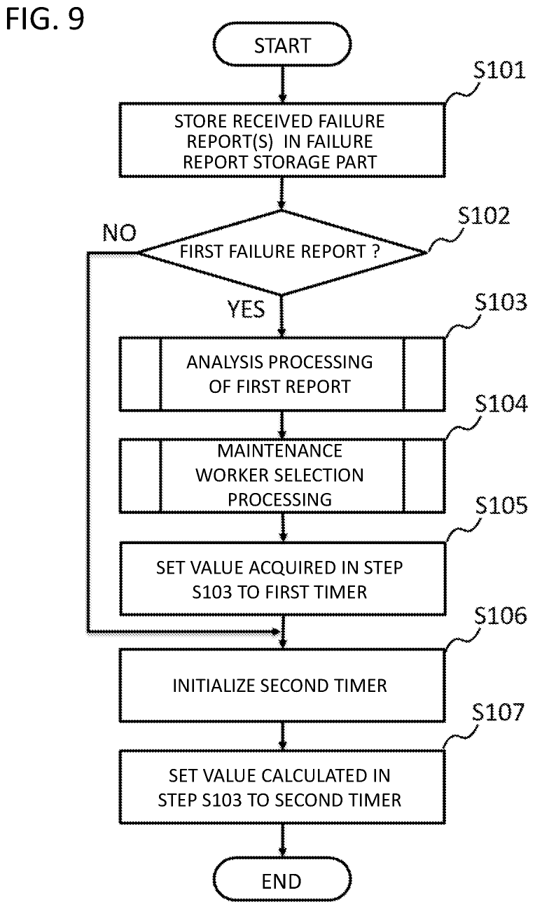

FIG. 9 is a flowchart illustrating a processing flow of the maintenance work instruction system according to the present example embodiment. The reception part 1 of the maintenance work instruction system 102 receives a failure report (failure alert) from the monitoring system 100 which has detected a failure. The reception part 1 transmits a failure report (failure alert) to the control part 2. The control part 2 stores the received failure report (failure alert) in the failure report storage part 4 (step S101). Hereinafter, in the following explanation, it is assumed that the failure report (failure alert) as shown in FIG. 8 is stored in the failure report storage part 4.

Next, the control part 2 checks that the first timer 8 is not set (step S102). As a result, it is possible to check whether or not it is a first failure report (failure alert) for a monitored apparatus concerned.

In step S102, if it is determined to be a first failure report (failure alert) (YES in step S102), the control part 2 performs “an analysis processing of the first report” (step S103). In “the analysis processing of the first report”, the control part 2 analyzes content of the failure report (failure alert) and determines X and Y which are variables of waiting time to be set to the first timer 8 and the second timer 9 (where, X>Y). Please note that, as a method for determining X and Y, for example, whether content of failures is local failure or inter-related failure is considered as a determination criterion. More concretely, if a “type” of a failure report (failure alert) is an “apparatus”, because it is considered a local failure, relatively shorter time can be set as X. On the other hand, if a “type” of a failure report (failure alert) is a “network”, because it is considered an inter-related failure, a larger value than that when the “type” is the “apparatus” can be set as X. As to Y, it may be a constant value irrespective of a “type” or a value may be selected by taking a “type” into consideration in the same way as that of X. Furthermore, the values of X and Y can be determined by using other information elements of the failure report (failure alert), such as “degree of importance” and “whether or not there is influence on service”. Furthermore, as X (a first value), it is possible to use a value calculated on the basis of a predetermined standard working time required for failure recovery.

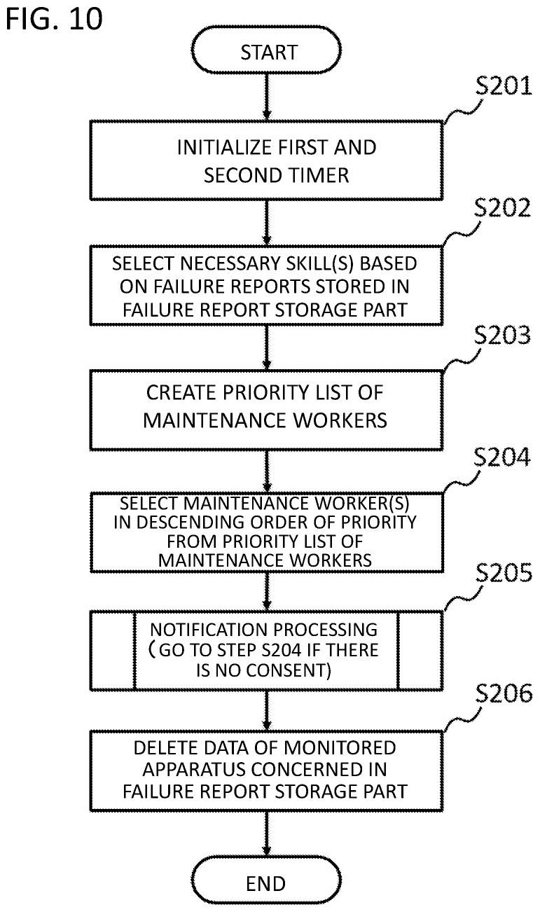

Next, the control part 2 of the maintenance work instruction system 102 performs a maintenance worker selection processing (step S104). As to details of the maintenance worker selection processing, it will be described in detail later using FIG. 10.

The control part 2 of the maintenance work instruction system 102 sets the first timer 8 to “after X seconds” (step S105). After that, aggregation of first failure reports (failure alerts) is started.

Next, the control part 2 of the maintenance work instruction system 102 initializes the second timer 9 (step S106). Furthermore, in the step S102, even if it is determined not to be the first failure report (failure alert) (NO in step S102), the control part 2 of the maintenance work instruction system 102 initializes the second timer 9 (step S106). Please note that if the second timer 9 is not operating, an initialization processing of the second timer 9 can be omitted.

Next, the control part 2 of the maintenance work instruction system 102 sets the second timer 9 to “after Y seconds” (step S107).

As described above, to accelerate a first response, selection of a maintenance worker(s) and a notification processing is once performed at the time of reception of the first failure report (failure alert), and after that, aggregation of failure reports (failure alerts) is started.

Next, a detailed flow of a “maintenance worker selection processing” will be described with reference to FIG. 10, which is triggered at the step S104 as shown in above FIG. 9 or when any one of the first timer 8 and the second timer 9 becomes 0 (zero).

When the present processing is called, the control part 2 of the maintenance work instruction system 102 performs selection of a maintenance worker(s) and transmission of a maintenance work instruction on the basis of a failure report(s) (failure alert(s)) of the monitored apparatus concerned which is held in the failure report storage part 4.

Concretely, first, the control part 2 of the maintenance work instruction system 102 initializes the first timer 8 and the second timer 9 (step S201). Please note that at the time of reception of the first failure report (failure alert) in step S104, because both the first timer 8 and the second timer 9 are not set, an initialization processing can be omitted.

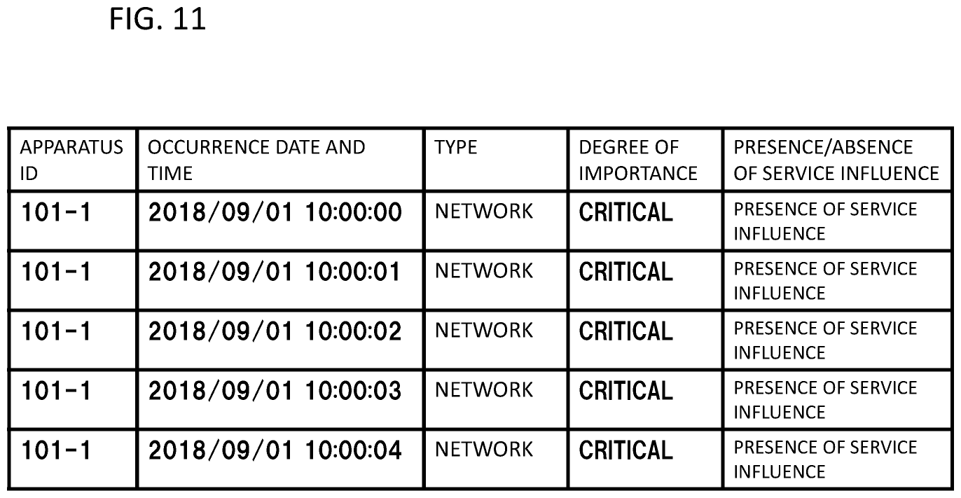

Next, the control part 2 of the maintenance work instruction system 102 acquires “skill(s) necessary for failure handling” for dealing with all the failures held in the failure report storage part 4 (step S202). Concretely, it can be determined by information of “type” of the failure report (failure alert). In the example as shown in FIG. 8, because there is only an alert whose “type” is “network”, it is judged that the “skill necessary for failure handling” is “network”. On the other hand, in the case of a second or subsequent failure report (failure alert), a plurality of failure reports (failure alerts) may be stored in the failure report storage part 4 as shown in FIG. 11. In this case, the “skill necessary for failure handling” becomes “network”.

Next, the control part 2 of the maintenance work instruction system 102 creates a priority list of the maintenance workers on the basis of “skill(s) necessary for failure handling” (step S203). Concretely, the control part 2 instructs the maintenance worker selection part 5 to calculate a degree of priority of notification on the basis of information of all the maintenance workers stored in the maintenance worker information table 3 and the “skill(s) necessary for failure handling” determined in step S202.

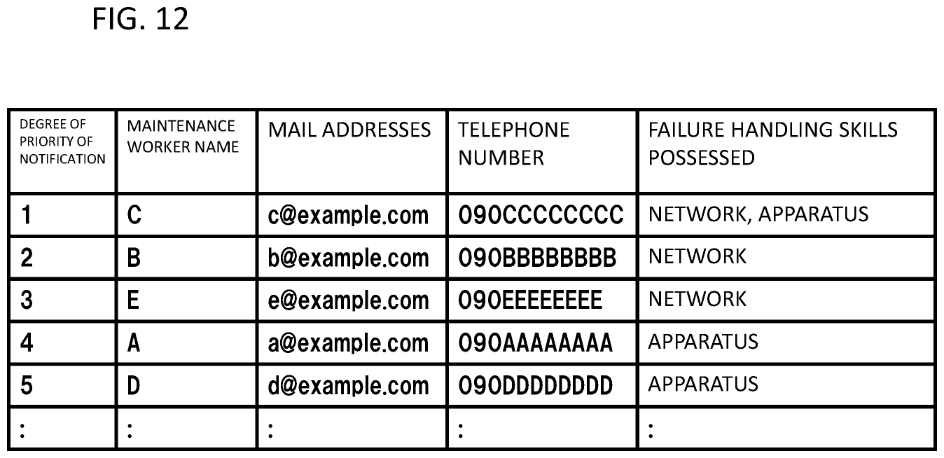

For example, if a plurality of failure reports (failure alerts) are stored as shown in FIG. 11 and “network” is required as a “skill necessary for failure handling”, a priority list of maintenance workers becomes to be one as shown in FIG. 12. In an example of FIG. 12, although a degree of matching between “skill(s) necessary for failure handling” and “failure handling skill(s) possessed” by maintenance workers is used as a decision criterion, it is possible to add presence information such as a present position(s) of a maintenance worker(s) and whether or not a maintenance worker(s) can be dispatched, and so on, to the decision criterion.

Next, the control part 2 of the maintenance work instruction system 102 selects a maintenance worker having a highest priority from the priority list of maintenance workers and transmits a maintenance work instruction (step S204, S205). For example, if a priority list of maintenance workers as shown in FIG. 12 is acquired, a maintenance worker C is selected first.

In the present example embodiment, a configuration in which a maintenance worker concerned is notified by telephone and mail is employed. Therefore, the control part 2 of the maintenance work instruction system 102 needs to respectively instruct notifications to the call sending and receiving system instruction part 6 and the mail transmission instruction part 7. Please note that as a result of the notification, if there is no consent (acknowledgement response) to accept the maintenance work instruction from a maintenance worker(s), the control part 2 of the maintenance work instruction system 102 selects a maintenance worker(s) of a next highest priority from the priority list of maintenance workers as shown in FIG. 12 and perform a maintenance work instruction by telephone and mail in the same way.

Finally, if consent (acknowledgement response) can be acquired from any of maintenance workers, the control part 2 of the maintenance work instruction system 102 deletes a failure report(s) (failure alert(s)) stored in the failure report storage part 4 (step S206). Please note that in place of deletion of the failure report(s) (failure alert(s)), the failure report(s) (failure alert(s)) stored in the failure report storage part 4 may be updated to “processed”.

As described above, the “maintenance worker selection processing” is finished. Here, an effect of the present example embodiment will be described. If it is determined to be the first failure report in step S102 of FIG. 9 and a first timer 8 is once started, after that, processings of S103 to S105 are not performed. As a result, the state of the first timer 8 is unchanged.

On the other hand, because processings of steps S106 and S107 are performed each time a failure report (failure alert) is received, the second timer 9 is reset to “after Y seconds” every time. In this way, the “maintenance worker selection processing” by the second timer 9 is postponed as long as a failure report (failure alert) is continuously issued within a predetermined time period.

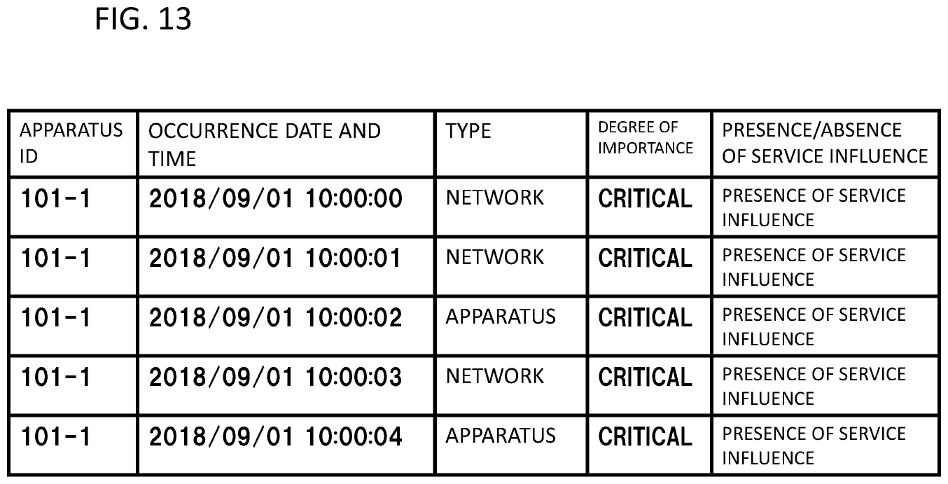

After that, similarly, a plurality of failure reports (failure alerts) are continuously issued within a predetermined time period and when the first timer becomes 0 (zero), the “maintenance worker selection processing” is called. At this time, in the failure report storage part 4, a plurality of failure reports (failure alerts) are stored as shown in FIG. 11. In this case, the “skill(s) necessary for failure handling” is determined to be “network”. Furthermore, if there exists a plurality of failure reports (failure alerts) of different “types” as shown in FIG. 13, a plurality of “skills necessary for failure handling” may be required therefor.

Next, the maintenance work instruction system 102 creates a priority list of maintenance workers on the basis of “skill(s) necessary for failure handling” and issues a maintenance work instruction to a maintenance worker(s) on the basis thereof. Therefore, in the present example embodiment, transmission of a maintenance work instruction to a maintenance worker(s) is not only suppressed simply, but reselection of a maintenance worker(s) is also performed on the basis of content of a failure report(s) (failure alert(s)) received during the suppression.

As described above, the present example embodiment is particularly effective when the monitoring system 100 detects some kind of failure and a plurality of failure alerts are issued in a short time period, and can select a maintenance worker(s) aggregately according to situation of a failure. Furthermore, by this, it is possible to prevent duplicated selections of maintenance workers which may occur when responding each of failure reports (failure alerts) individually, and to make assignment of personnel resources more efficient.

Although each example embodiment of the present invention is described as above, the present invention is not limited to the above example embodiments and further variations, substitutions and adjustments can be made in the scope without departing from the basic technical concept of the present invention. For example, a network configuration, a configuration of each element and a representation format of a message illustrated in each drawing are one example to facilitate understanding of the present invention and are not limited to the configurations as illustrated in the drawings.

For example, in the above example embodiments, although the maintenance work instruction system 102 is explained in such manner that it receives a failure report (failure alert) from the monitoring system 100, a mode to receive a failure report (failure alert) is not limited thereto. For example, it may be possible for a maintenance work instruction system 102 to have a configuration to directly receive a failure report (failure alert) from the monitored apparatus 101-1, 101-2.

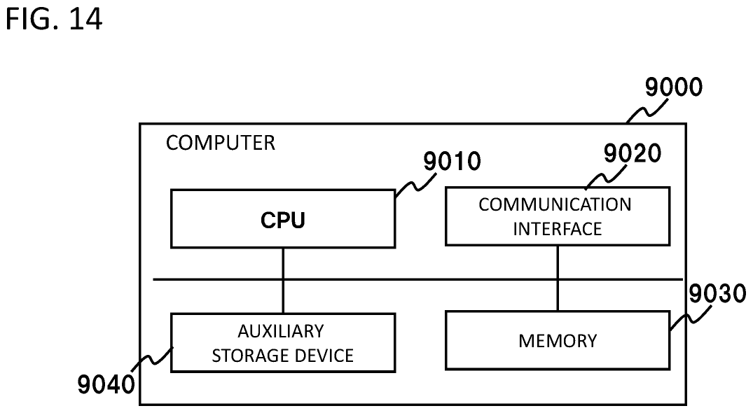

Furthermore, procedures as described in the above example embodiments can be realized by a program which causes a computer (9000 as shown in FIG. 14) functioning as a maintenance work instruction system 102 to realize functions as a maintenance work instruction system 102. Such a computer is exemplified by a configuration including a CPU (central Processing Unit) 9010, a communication interface 9020, a memory 9030, and an auxiliary storage device 9040 of FIG. 14. That is, the CPU 9010 of FIG. 14 may execute a failure report analysis program and a maintenance worker selection program and update each calculation parameter held in its auxiliary storage device 9040 and so on.

That is, each part (processing means, and function) of the maintenance work instruction system as described in the above example embodiments can be realized by a computer making up a maintenance work instruction system. Concretely, it can be realized by a computer program which causes a processor mounted on the computer, using its hardware, to execute each processing as described above.

Finally, suitable modes of the present invention will be summarized.

### [Mode 1]

(See the maintenance work instruction system according to the above first aspect)

### [Mode 2]

It is possible to employ a configuration in which the maintenance work instruction system as described above further comprises:
a failure report storage part which stores the failure reports,
wherein failure reports are accumulated in the failure report storage part during a time period after the first failure report until a lapse of time defined by the first value or a lapse of time defined by the second value in the second timer, whichever comes first, and
wherein the maintenance worker selection part selects a maintenance worker(s) on the basis of the failure reports accumulated in the failure report storage part.

### [Mode 3]

It is possible to employ a configuration in which in the maintenance work instruction system as described above, wherein the maintenance worker selection part determines whether failure(s) is local failure(s) or inter-related failures on the basis of information included in the failure report(s) received during a predetermined time period and selects a maintenance worker(s) who can handle respective failures if it is determined that they are the inter-related failures.

### [Mode 4]

It is possible to employ a configuration in which in the maintenance work instruction system as described above, wherein the first value is set on the basis of a predetermined standard operation time required for failure recovery.

### [Mode 5]

It is possible to employ a configuration in which in the maintenance work instruction system as described above, wherein
the maintenance worker selection part creates a priority list of the maintenance workers on the basis of information included in the failure report(s) received during a predetermined time period, and
the notification part selects a maintenance worker(s) on the basis of the priority list.

### [Mode 6]

It is possible to employ a configuration in which in the maintenance work instruction system as described above, wherein, if there is no acknowledgement response from a maintenance worker(s) who is(are) notified on the basis of the priority list, the notification part selects a maintenance worker(s) of a next highest priority and transmits a maintenance work instruction.

### [Mode 7]

(See the maintenance work instruction method according to the above second aspect)

### [Mode 8]

(See the program according to the above third aspect)
The above modes 7 and 8 can be expanded in the same way as mode 1 is expanded to modes 2 to 6.

Each disclosure of the above Patent Literatures is incorporated herein by reference thereto and is regarded to be described therein, and can be used as a basis and a part of the present invention if needed. Variations and adjustments of the example embodiments and examples are possible within the scope of the overall disclosure (including the claims) of the present invention and based on the basic technical concept of the present invention. Various combinations and selections (including partial deletion) of various disclosed elements (including the elements in each of the claims, example embodiments, examples, drawings, etc.) are possible within the scope of the entire disclosure of the present invention. Namely, the present invention of course includes various variations and modifications that could be made by those skilled in the art according to the overall disclosure including the claims and the technical concept. In particular, with respect to the numerical ranges described herein, any numerical values or small range(s) included in the ranges should be construed as being expressly described even if not particularly mentioned. Furthermore, each disclosure of above cited documents and also using a part or all thereof by combining with the disclosure of the present application are regarded as being included in the disclosure of the present application, as necessary, in accordance with the gist of the present invention, as a part of the disclosure of the present invention.

### REFERENCE SIGNS LIST

1, 11 reception part
2, 14 control part
3 maintenance worker information table
4 failure report storage part
5, 12 maintenance worker selection part
6 call sending and receiving system instruction part
7 mail transmission instruction part
8, 15 first timer
9, 16 second timer
10, 102 maintenance work instruction system
13 notification part
100 monitoring system
101-1 to 101-2 monitored apparatus
103 call sending and receiving system
104 telephone network
105 IP (Internet Protocol) network
9000 computer
9010 CPU
9020 communication interface
9030 memory
9040 auxiliary storage device

What is claimed is:

1. A maintenance work instruction system, comprising:
at least a processor; and
a memory in circuit communication with the processor,
wherein the processor is configured to execute program instructions stored in the memory to implement:
a first timer and a second timer managed for each monitored apparatus;
a reception part which receives a failure report(s) from the monitored apparatus;
a maintenance worker selection part which selects a maintenance worker(s) on the basis of the failure report(s) received during a predetermined time period;
a notification part which transmits a work instruction to the selected maintenance worker(s); and
a control part which determines a first value and a second value on the basis of information included in the failure report(s) and sets them to the first timer and the second timer,
wherein
the control part, if a failure report is received from a monitored apparatus to which the first timer is not set, sets the first value to the first timer, and
after that, during a time period until the first timer measures time defined by the first value, if a failure report is received from an identical monitored apparatus, by setting the second value shorter than the first value to the second timer, aggregates received failure reports during a time period after the first failure report until a lapse of time defined by the first value or a lapse of time defined by the second value in the second timer, whichever comes first.

2. The maintenance work instruction system according to claim 1, wherein the processor is configured to execute the program instructions to implement:
a failure report storage part which stores the failure reports,
wherein failure reports are accumulated in the failure report storage part during a time period after the first failure report until a lapse of time defined by the first value or a lapse of time defined by the second value in the second timer, whichever comes first, and
wherein the maintenance worker selection part selects a maintenance worker(s) on the basis of the failure reports accumulated in the failure report storage part.

3. The maintenance work instruction system according to claim 1, wherein the maintenance worker selection part determines whether failure(s) is local failure(s) or inter-related failures on the basis of information included in the failure report(s) received during a predetermined time period and sets a lager value than a value in the case of the local failure(s) as the first value if it is determined that it is the inter-related failures.

4. The maintenance work instruction system according to claim 1, wherein the first value is set on the basis of a predetermined standard operation time required for failure recovery.

5. The maintenance work instruction system according to claim 1, wherein
the maintenance worker selection part creates a priority list of the maintenance workers on the basis of information included in the failure report(s) received during a predetermined time period, and
the notification part selects a maintenance worker(s) on the basis of the priority list.

6. The maintenance work instruction system according to claim 5, wherein, if there is no acknowledgement response from a maintenance worker(s) who is(are) notified on the basis of the priority list, the notification part selects a maintenance worker(s) of a next highest priority and transmits a maintenance work instruction.

7. A maintenance work instruction method, wherein a computer comprises:
a first timer and a second timer managed for each monitored apparatus;
a reception part which receives a failure report(s) from the monitored apparatus;
a maintenance worker selection part which selects a maintenance worker(s) on the basis of the failure report(s) received during a predetermined time period;
a notification part which transmits a work instruction to the selected maintenance worker(s); and
a control part which determines a first value and a second value on the basis of information included in the failure report(s) and sets them to the first timer and the second timer,
wherein
the computer, if a failure report is received from a monitored apparatus to which the first timer is not set, sets the first value to the first timer, and
after that, during a time period until a value of the first timer comes, if a failure report is received from an identical monitored apparatus, by setting the second value shorter than the first value to the second timer, aggregates received failure reports during a time period after the first failure report until a lapse of time defined by the first value or a lapse of time defined by the second value in the second timer, whichever comes first.

8. The maintenance work instruction method according to claim 7, wherein the computer further comprises a failure report storage part which stores the failure reports,
wherein failure reports are accumulated in the failure report storage part during a time period after the first failure report until a lapse of time defined by the first value or a lapse of time defined by the second value in the second timer, whichever comes first, and
wherein the maintenance worker selection part selects a maintenance worker(s) on the basis of the failure reports accumulated in the failure report storage part.

9. The maintenance work instruction method according to claim 7, wherein it is determined whether failure(s) is local failure(s) or inter-related failures on the basis of information included in the failure report(s) received during a predetermined time period and a lager value than a value in the case of the local failure(s) is set as the first value if it is determined that it is the inter-related failures.

10. A computer-readable non-transient recording medium recording a program, the program which causes a computer comprising:
a first timer and a second timer managed for each monitored apparatus;
a reception part which receives a failure report(s) from the monitored apparatus;
a maintenance worker selection part which selects a maintenance worker(s) on the basis of the failure report(s) received during a predetermined time period;
a notification part which transmits a work instruction to the selected maintenance worker(s); and
a control part which determines a first value and a second value on the basis of information included in the failure report(s) and sets them to the first timer and the second timer,
to execute processings, comprising:
if a failure report is received from a monitored apparatus to which the first timer is not set, setting the first value to the first timer, and
after that, during a time period until a value of the first timer comes, if a failure report is received from an identical monitored apparatus, by setting the second value shorter than the first value to the second timer, aggregating received failure reports during a time period after the first failure report until a lapse of time defined by the first value or a lapse of time defined by the second value in the second timer, whichever comes first.

11. The maintenance work instruction method according to claim 7, wherein the first value is set on the basis of a predetermined standard operation time required for failure recovery.

12. The maintenance work instruction method according to claim 7, wherein
creates a priority list of the maintenance workers on the basis of information included in the failure report(s) received during a predetermined time period, and
selects a maintenance worker(s) on the basis of the priority list.

13. The maintenance work instruction method according to claim 12, wherein, if there is no acknowledgement response from a maintenance worker(s) who is(are) notified on the basis of the priority list, selects a maintenance worker(s) of a next highest priority and transmits a maintenance work instruction.

14. The computer-readable non-transient recording medium according to claim 10, wherein the computer further comprises a failure report storage part which stores the failure reports,
wherein the program causes the computer to execute processings, comprising:
accumulating failure reports in the failure report storage part during a time period after the first failure report until a lapse of time defined by the first value or a lapse of time defined by the second value in the second timer, whichever comes first, and
selecting a maintenance worker(s) on the basis of the failure reports accumulated in the failure report storage part.

15. The computer-readable non-transient recording medium according to claim 10, wherein the program causes the computer to execute processings, comprising:
determining whether failure(s) is local failure(s) or inter-related failures on the basis of information included in the failure report(s) received during a predetermined time period and
setting a lager value than a value in the case of the local failure(s) as the first value if it is determined that it is the inter-related failures.

16. The computer-readable non-transient recording medium according to of claim 10, wherein the first value is set on the basis of a predetermined standard operation time required for failure recovery.

17. The computer-readable non-transient recording medium according to claim 10, wherein the program causes the computer to execute processings, comprising:
creating a priority list of the maintenance workers on the basis of information included in the failure report(s) received during a predetermined time period, and
selecting a maintenance worker(s) on the basis of the priority list.

18. The medium according to claim 17, wherein, the program causes the computer to execute processings, comprising:
if there is no acknowledgement response from a maintenance worker(s) who is(are) notified on the basis of the priority list, selecting a maintenance worker(s) of a next highest priority and transmits a maintenance work instruction.
